(19) United States
(12) Patent Application Publication
(10) Pub. No.: US 2022/0237416 A1
(43) Pub. Date: Jul. 28, 2022

(54) LEARNING APPARATUS, LEARNING METHOD, COMPUTER PROGRAM AND RECORDING MEDIUM

(71) Applicant: NEC Corporation, Minato-ku, Tokyo (JP)

(72) Inventors: Toshinori Araki, Tokyo (JP); Takuma Amada, Tokyo (JP); Kazuya Kakizaki, Tokyo (JP)

(73) Assignee: NEC Corporation, Minato-ku, Tokyo (JP)

(21) Appl. No.: 17/610,497

(22) PCT Filed: May 21, 2019
(86) PCT No.: PCT/JP2019/020057

§ 371 Date: Nov. 11, 2021

(51) Int. Cl. G06K 9/62; G06N 3/08; G06N 3/04

(52) U.S. Cl. CPC G06K 9/6262; G06K 9/6215; G06N 3/0454; G06N 3/08

(57) ABSTRACT

A learning apparatus includes: a prediction loss calculating device that calculates a prediction loss function based on an error between outputs of machine learning models to which training data is inputted and a ground truth label; a gradient loss calculating device that calculates a gradient loss function based on a gradient of the prediction loss function; and an updating device that performs an update operation of updating the machine learning models on the basis of the prediction loss function and the gradient loss function, the gradient loss calculating device calculates the gradient loss function based on the gradient when the number of times which the update operation is performed is smaller than a predetermined number, and calculates a function that represents zero as the gradient loss function when the number of times which the update operation is performed is larger than the predetermined number.

### TECHNICAL FIELD

The present invention relates to a technical field of a learning apparatus, a learning method, a computer program and a recording medium that updates a machine learning model.

### BACKGROUND ART

A machine learning model (for example, a machine learning model using a neural network) that is learned by using a deep learning and so on has vulnerability regarding an adversarial example that is generated to deceive the machine learning model. Specifically, when the adversarial example is inputted to the machine learning model, there is a possibility that the machine learning model cannot correctly classify (namely, misclassify) the adversarial example. For example, when a sample that is inputted to the machine learning model is an image, an image that is classified into a class “A” by humans but that is classified into class “B” when it is inputted to the machine learning model is used as the adversarial example.

Thus, it is desired to build the machine learning model that is robust against the adversarial example. For example, a Non-Patent Literature 1 discloses one example of a method of building the machine learning model that is robust against the adversarial example. Specifically, the Non-Patent Literature 1 discloses a method of building the machine learning model that is robust against the adversarial example by updating a plurality of machine learning models (specifically, updating parameters of the plurality of machine learning models) so as to reduce a space in which there is the adversarial example that is misclassified by all of the plurality of machine learning models on the basis of a first loss function of the plurality of machine learning models and a second loss function based on a gradient of the first loss function.

### CITATION LIST

### Non-Patent Literature

Non-Patent Literature 1: Sanjay Kariyappa, Moinuddin K. Qureshi, “Improving Adversarial Robustness of Ensembles with Diversity Training”, arxiv: 1901.9981, Jan. 28, 2019.

### SUMMARY OF INVENTION

### Technical Problem

The method disclosed in the Non-Patent Literature 1 has such a constraint that a specific function must be used as an activation function of the machine learning model. Specifically, the method disclosed in the Non-Patent Literature 1 has such a constraint that not a ReLu (Rectified Linear Unit) function but a Leaky ReLu function must be used as the activation function of the machine learning model. This is because the method disclosed in the Non-Patent Literature used the second loss function based on the gradient of the first loss function, and thus, an influence of the gradient of the first loss function to the update of the machine learning model (namely, a degree of contribution of the second loss function to the update of the machine learning model) is reduced by the ReLu function the gradient of which is zero (namely, a differential coefficient of which is zero) in a relatively wide range.

However, when the Leaky ReLu function is used as the activation function, a processing load necessary for updating the machine learning model is higher, compared to the case where another function such as the ReLu function is used as the activation function. This is because the differential coefficient of the Leaky ReLu function is not constant. Thus, the method disclosed in the Non-Patent Literature 1 has such a technical problem that there is room for improvement in terms of reducing the processing load.

It is therefore an example object of the present invention to provide a learning apparatus, a learning method, a computer program and a recording medium that can solve the technical problems described above. By way of example, an example object of the present invention is to provide a learning apparatus, a learning method, a computer program and a recording medium that can update a machine learning model with relatively low processing load.

### Solution to Problem

A first example aspect of a learning apparatus for solving the technical problem includes: a prediction loss calculating device that calculates a prediction loss function based on an error between outputs of a plurality of machine learning models to which training data is inputted and a ground truth label corresponding to the training data; a gradient loss calculating device that calculates a gradient loss function based on a gradient of the prediction loss function; and an updating device that performs an update operation of updating the plurality of machine learning models on the basis of the prediction loss function and the gradient loss function, the gradient loss calculating device (i) calculates the gradient loss function based on the gradient when the number of times which the update operation is performed is smaller than a predetermined number, and (ii) calculates a function that represents zero as the gradient loss function when the number of times which the update operation is performed is larger than the predetermined number.

A second example aspect of a learning apparatus for solving the technical problem includes: a prediction loss calculating device that calculates a prediction loss function based on an error between outputs of a plurality of machine learning models to which training data is inputted and a ground truth label corresponding to the training data; a gradient loss calculating device that calculates a gradient loss function based on a gradient of the prediction loss function; and an updating device that performs an update operation of updating the plurality of machine learning models on the basis of at least one of the prediction loss function and the gradient loss function, the updating device (i) performs the update operation on the basis of both of the prediction loss function and the gradient loss function when the number of times which the update operation is performed is smaller than a predetermined number, and (ii) performs the update operation on the basis of the prediction loss function without using the gradient loss function when the number of times which the update operation is performed is larger than the predetermined number.

A first example aspect of a learning method for solving the technical problem includes: a prediction loss calculating step that calculates a prediction loss function based on an error between outputs of a plurality of machine learning models to which training data is inputted and a ground truth label corresponding to the training data; a gradient loss calculating step that calculates a gradient loss function based on a gradient of the prediction loss function; and an updating step that performs an update operation of updating the plurality of machine learning models on the basis of the prediction loss function and the gradient loss function, at the gradient loss calculating step, (i) the gradient loss function based on the gradient is calculated when the number of times which the update operation is performed is smaller than a predetermined number, and (ii) a function that represents zero is calculated as the gradient loss function when the number of times which the update operation is performed is larger than the predetermined number.

A second example aspect of a learning method for solving the technical problem includes: a prediction loss calculating step that calculates a prediction loss function based on an error between outputs of a plurality of machine learning models to which training data is inputted and a ground truth label corresponding to the training data; a gradient loss calculating step that calculates a gradient loss function based on a gradient of the prediction loss function; and an updating step that performs an update operation of updating the plurality of machine learning models on the basis of at least one of the prediction loss function and the gradient loss function, at the updating step, (i) the update operation is performed on the basis of both of the prediction loss function and the gradient loss function when the number of times which the update operation is performed is smaller than a predetermined number, and (ii) the update operation is performed on the basis of the prediction loss function without using the gradient loss function when the number of times which the update operation is performed is larger than the predetermined number.

One example aspect of a computer program for solving the technical problem allows a computer to perform the first or second example aspect of the learning method described above.

One example aspect of a recording medium for solving the technical problem is a recording medium on which the one example aspect of the computer program described above is recorded.

### Advantageous Effects of Invention

According to the example aspect of each of the learning apparatus, the learning method, the computer program and the recording medium described above, the machine learning model can be updated with a relatively low processing load.

### BRIEF DESCRIPTION OF DRAWINGS

FIG. 1 is a block diagram that illustrates a hardware configuration of a learning apparatus in the present example embodiment.

FIG. 2 is a block diagram that illustrates a functional block implemented in a CPU in the present example embodiment.

FIG. 3 is a flow chart that illustrates a flow of an operation of the learning apparatus in the present example embodiment.

FIG. 4 is a flow chart that illustrates a flow of a modified example of the operation of the learning apparatus in the present example embodiment.

FIG. 5 is a block diagram that illustrates a modified example of the functional block implemented in the CPU.

### DESCRIPTION OF EXAMPLE EMBODIMENTS

Hereinafter, an example embodiment of a learning apparatus, a learning method, a computer program and a recording medium will be described with reference to the drawings. The following describes the example embodiment of the learning apparatus, the learning method, the computer program and the recording medium by using a learning apparatus 1 that allows n (wherein, n is an integer that is equal to or larger than 2) machine learning models f₁, f₂, . . . , fₙ₋₁ and fₙ to learn by using a training data set DS to update the n machine learning models f₁ to fₙ.

### (1) Configuration of Learning Apparatus 1

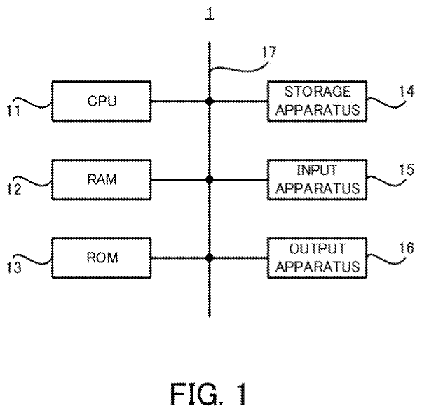

First, with reference to FIG. 1, a hardware configuration of the learning apparatus 1 in the present example embodiment will be described. FIG. 1 is a block diagram that illustrates the hardware configuration of the learning apparatus 1 in the present example embodiment.

As illustrated in FIG. 1, the learning apparatus 1 is provided with a CPU (Central Processing Unit) 11, a RAM (Random Access Memory) 12, a ROM (Read Only Memory) 13, a storage apparatus 14, an input apparatus 15, and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not illustrated apparatus disposed outside the learning apparatus 1, through a network interface. The CPU 11 controls the RAM 12, the storage apparatus 14, the input apparatus 15, and the output apparatus 16 by executing the read computer program. Especially in the present example embodiment, when the CPU 11 executes the read computer program, a logical functional block(s) for updating the machine learning models f₁ to fₙ is implemented in the CPU 11. In other words, the CPU 11 is configured to function as a controller for implementing a logical functional block for updating the machine learning models f₁ to fₙ.

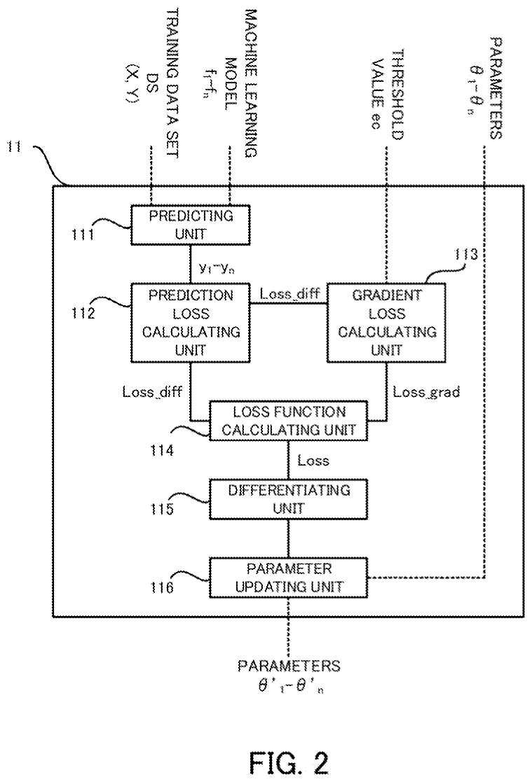

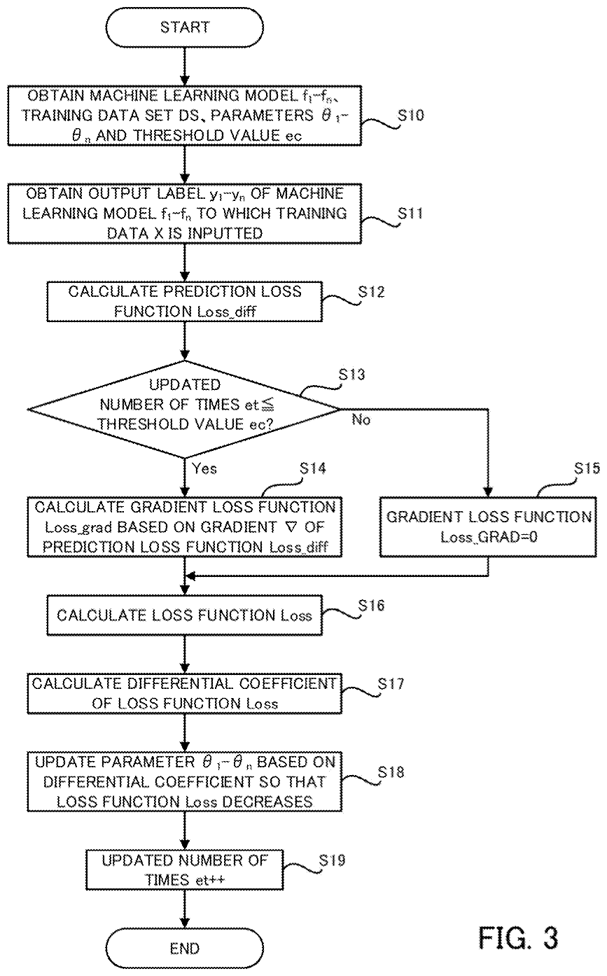

As illustrated in FIG. 2, a predicting unit 111, a prediction loss calculating unit 112 that is one specific example of a “prediction loss calculating device” in a Supplementary Note described later, a gradient loss calculating unit 113 that is one specific example of a “gradient loss calculating device” in the Supplementary Note described later, a loss function calculating unit 114, a differentiating unit 115 and a parameter updating unit 116 that is one specific example of an “updating device” in the Supplementary Note described later, are implemented in the CPU 11 as the logical functional block for updating the machine learning models f₁ to fₙ. Note that an operation of each of the predicting unit 111, the prediction loss calculating unit 112, the gradient loss calculating unit 113, the loss function calculating unit 114, the differentiating unit 115 and the parameter updating unit 116 will be described later in detail with reference to FIG. 3 and so on, and thus, a detailed description thereof is omitted here.

Again in FIG. 1, the RAM 12 temporarily stores the computer program to be executed by the CPU 11. The RAM 12 temporarily stores the data that are temporarily used by the CPU 11 when the CPU 11 executes the computer program. The RAM 12 may be, for example, a D-RAM (Dynamic RAM).

The ROM 13 stores a computer program to be executed by the CPU 11. The ROM 13 may otherwise store fixed data. The ROM 13 may be, for example, a P-ROM (Programmable ROM).

The storage apparatus 14 stores the data that are stored for a long term by the learning apparatus 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the learning apparatus 1. The input apparatus 15 may include, for example, at least one of a keyboard, a mouse, and a touch panel.

The output apparatus 16 is an apparatus that outputs information about the learning apparatus 1, to the outside. For example, the output apparatus 16 may be a display apparatus that is configured to display the information about the learning apparatus 1.

### (2) Flow of Operation of Learning Apparatus 1

Next, with reference to FIG. 3, a flow of an operation of the learning apparatus 1 in the present example embodiment (that is, the operation of updating the machine learning models f₁ to fₙ) will be described. FIG. 3 is a flow chart illustrating the flow of the operations of the learning apparatus 1 in the present example embodiment.

As illustrated in FIG. 3, the learning apparatus 1 (especially, the CPU 11) obtains information that is necessary for updating the machine learning models f₁ to fₙ (a step S10). Specifically, the learning apparatus 1 obtains the machine learning models f₁ to fₙ that are targets for the update. Moreover, the learning apparatus 1 obtains training data set DS that is used to update (namely, learn) the machine learning models f₁ to fₙ. Moreover, the learning apparatus 1 obtains a parameter θ₁ that defines a behavior of the machine learning model f₁, a parameter θ₂ that defines a behavior of the machine learning model f₂, . . . , a parameter θₙ₋₁ that defines a behavior of the machine learning model fₙ₋₁ and a parameter θₙ that defines a behavior of the machine learning model fₙ. Moreover, the learning apparatus 1 obtains a threshold value ec.

Each of the machine learning models f₁ to fₙ is a machine learning model based on a neural network. However, each of the machine learning models f₁ to fₙ may be another type of machine learning model.

The training data set DS is a data set that includes a plurality of unit data each of which includes training data (namely, training sample) X and a ground truth label Y The training data X is a data that is inputted to each of the machine learning models f₁ to fₙ to update the machine learning models f₁ to fₙ. The ground truth label Y indicates a label (in other words, a classification) of the training data X. Namely, the ground truth label Y indicates a label that should be outputted from each of the machine learning models f₁ to fₙ when the training data X corresponding to the ground truth label Y is inputted to each of the machine learning models f₁ to fₙ.

When the machine learning model fₖ (note that k is an integer that satisfies 1≤k≤n) is the machine learning model based on the neural network, the parameter θₖ of the machine learning model fₖ may include a parameter of the neural network. The parameter of the neural network may include at least one of a bias and a weight in each node that constitutes the neural network. Note that it is assumed that the operation of updating the machine learning models f₁ to fₙ is an operation of updating the parameters θ₁ to θₙ. Namely, it is assumed that the learning apparatus 1 updates the machine learning models f₁ to fₙ by updating the parameters θ₁ to θₙ.

The threshold value ec is a threshold value that is used to be compared to the number of times which the parameters θ₁ to θₙ are updated (hereinafter, this is referred to as an “updated number of times et”). Since the parameters θ₁ to θₙ are updated by the operation illustrated in FIG. 3 being performed, the updated number of times et may mean the number of times which the operation illustrated in FIG. 3 is performed. A comparison result of the updated number of times et and the threshold value ec is used when the gradient loss calculating unit 113 calculates a gradient loss function Loss_grad described later in detail.

Then, the predicting unit 111 inputs the training data X to each of the machine learning models f₁ to fₙ and obtains labels (hereinafter, these are referred to as “output labels”) y₁ to yₙ that are outputted from the machine learning models f₁ to fₙ, respectively (a step S11). Namely, the predicting unit 111 obtains the output label y₁ that is outputted from the machine learning model f₁ to which the training data X is inputted, the output label y₂ that is outputted from the machine learning model f₂ to which the training data X is inputted, . . . , the output label yₙ₋₁ that is outputted from the machine learning model fₙ₋₁ to which the training data X is inputted and the output label yₙ that is outputted from the machine learning model fₙ to which the training data X is inputted. The output labels y₁ to yₙ are outputted to the prediction loss calculating unit 112.

Then, the prediction loss calculating unit 112 calculates a prediction loss function Loss_diff on the basis of the output labels y₁ to yₙ and the ground truth label Y (a step S12). Specifically, the prediction loss calculating unit 112 calculates a prediction loss function Loss_diffₖ based on an error between the output label yₖ and the ground truth label Y Namely, the prediction loss calculating unit 112 calculates a prediction loss function Loss_diff₁ based on an error between the output label y₁ and the ground truth label Y, a prediction loss function Loss_diff₂ based on an error between the output label y₂ and the ground truth label Y, . . . , a prediction loss function Loss_diffₙ₋₁ based on an error between the output label yₙ₋₁ and a prediction loss function Loss_diffₙ based on an error between the output label yₙ and the ground truth label Y Note that this error between the output label y and the ground truth label Y is a cross entropy error, for example, however, may be another type of error (for example, a squared error). Namely, the prediction loss function Loss_diff is a loss function that can express the error between the output label y and the ground truth label Y as the cross entropy error, however, may be another type of loss function. Moreover, when the cross entropy error is used, a softmax function is used as an activation function (especially, an activation function of an output layer) of the machine learning models f₁ to fₙ, however, another type of activation function (for example, at least one of a ReLu function and a Leaky ReLu function) may be used.

Then, the gradient loss calculating unit 113 determines whether or not the updated number of times et is equal to or smaller than the threshold value ec (a step S13). The threshold value ec is typically a constant number that is set to an integer that is equal to or larger than 1. However, the gradient loss calculating unit 113 may change the threshold value ec, if needed. Namely, the gradient loss calculating unit 113 may change the threshold value ec that is obtained by the learning apparatus 1, if needed.

As a result of a determination at the step S13, when it is determined that the updated number of times et is equal to or smaller than the threshold value ec (the step S13: Yes), the gradient loss calculating unit 113 calculates the gradient loss function Loss_grad based on a gradient ∇ of the prediction loss function Loss_diff (a step S14). Here, one example of a method of calculating the gradient loss function Loss_grad will be described. However, the gradient loss calculating unit 113 may calculate the gradient loss function Loss_grad based on a gradient ∇ of the prediction loss function Loss_diff by using a method that is different from the below described method.

Firstly, the gradient loss calculating unit 113 calculates the gradient ∇ₖ of the prediction loss function Loss_diffₙ on the basis of a below described equation 1. Namely, the gradient loss calculating unit 113 calculates the gradient ∇₁ of the prediction loss function Loss_diff₁, the gradient ∇₂ of the prediction loss function Loss_diff₂, . . . , the gradient ∇ₙ₋₁ of the prediction loss function Loss_diffₙ₋₁ and the gradient ∇ₙ of the prediction loss function Loss_diffₙ on the basis of the below described equation 1. The below described equation 1 means that a gradient (namely, a gradient vector) of the reduction loss function Loss_diffₙ with respect to the training data X is used as the gradient ∇ₖ of the prediction loss function Loss_diffₙ.

$${∇}_{k} = \frac{\partial {Loss\_diff}_{k}}{\partial X} \qquad [ Equation 1 ]$$

Then, the gradient loss calculating unit 113 calculates the gradient loss function Loss_grad on the basis of a similarity of the gradients ∇₁ to ∇ₙ. Specifically, the gradient loss calculating unit 113 calculates the similarity of two gradients ∇ of the gradients ∇₁ to ∇ₙ for all combinations of two gradients ∇. Namely, the gradient loss calculating unit 113 calculates (1) the similarity of the gradient ∇₁ and the gradient ∇₂, the similarity of the gradient ∇₁ and the gradient ∇₃, . . . , the similarity of the gradient ∇₁ and the gradient ∇ₙ₋₁ and the similarity of the gradient ∇₁ and the gradient ∇ₙ, (2) the similarity of the gradient ∇₂ and the gradient ∇₃, the similarity of the gradient ∇₂ and the gradient ∇₄, . . . , the similarity of the gradient ∇₂ and the gradient ∇ₙ₋₁ and the similarity of the gradient ∇₂ and the gradient ∇ₙ, . . . , (n−2) the similarity of the gradient ∇ₙ₋₂ and the gradient ∇ₙ₋₁ and the similarity of the gradient ∇ₙ₋₂ and the gradient ∇ₙ, and (n−1) the similarity of the gradient ∇ₙ₋₁ and the gradient ∇ₙ. In this case, the gradient loss calculating unit 113 may use, as the similarity of the gradient ∇ᵢ and the gradient ∇ⱼ, any index that can quantitively represents how much the gradient ∇ᵢ and the gradient ∇ⱼ are similar. As one example, as illustrated in a below described equation 2, the gradient loss calculating unit 113 may use, as the similarity of the gradient ∇ᵢ and the gradient ∇ⱼ, a cosine similarity cosᵢⱼ of the gradient ∇ᵢ and the gradient ∇ⱼ. Then, the gradient loss calculating unit 113 calculates, as the gradient loss function Loss_grad, a total sum of the calculated similarities. As one example, when the cosine similarity cosᵢⱼ of the gradient ∇ᵢ and the gradient ∇ⱼ is used, the gradient loss calculating unit 113 calculates the gradient loss function Loss_grad by using a below described equation 3. Alternatively, the gradient loss calculating unit 113 may calculate, as the gradient loss function Loss_grad, a value based on the total sum of the calculated similarities (for example, a value that is proportional to the total sum of the calculated similarities).

$${cos}_{ij} = \frac{{∇}_{i} \cdot {∇}_{j}}{‖ {∇}_{i} ‖ ‖ {∇}_{j} ‖} \\ Loss\_grad = {\sum }_{i = 1 , j = 1 , i \neq j}^{n} {cos}_{ij} \qquad [ Equation 2 ]$$

On the other hand, as a result of the determination at the step S13, when it is determined that the updated number of times et is not equal to or smaller than the threshold value ec (namely, the updated number of times et is larger than the threshold value ec) (the step S13: No), the gradient loss calculating unit 113 calculates a function that represents zero as the gradient loss function Loss_grad, instead of calculating the gradient loss function Loss_grad based on the gradient ∇ (a step S15). Namely, the gradient loss calculating unit 113 sets the function that represents zero to the gradient loss function Loss_grad independently from the gradient ∇.

Note that the gradient loss calculating unit 113 calculate the gradient loss function Loss_grad based on the gradient ∇ when the updated number of times et is equal to the threshold value ec in the above described description. However, the gradient loss calculating unit 113 may calculate, the function that represents zero as the gradient loss function Loss_grad when the updated number of times et is equal to the threshold value ec. Namely, at the step S13, the gradient loss calculating unit 113 may determine whether or not the updated number of times et is smaller than the threshold value ec, instead of determining whether or not the updated number of times et is equal to or smaller than the threshold value ec.

Then, the loss function calculating unit 114 calculates a final loss function Loss that is should be used to update the machine learning models f₁ to fₙ (namely, to update the parameters θ₁ to θₙ) on the basis of the prediction loss function Loss_diff calculated at the step S12 and the gradient loss function Loss_grad calculated at the step S14 or S15 (a step S16). In this case, the loss function calculating unit 114 may calculate the loss function Loss by using any method, as long as both of the prediction loss function Loss_diff and the gradient loss function Loss_grad are reflected in the loss function Loss. For example, the loss function calculating unit 114 may calculate, as the loss function Loss, a sum of the prediction loss function Loss_diff and the gradient loss function Loss_grad. Namely, the loss function calculating unit 114 may calculate the loss function Loss by using an equation “the loss function Loss=the prediction loss function Loss_diff+the gradient loss function Loss_grad”. For example, the loss function calculating unit 114 may calculate, as the loss function Loss, a sum of the prediction loss function Loss_diff and the gradient loss function Loss_grad on at least one of which a weighting process is performed. Namely, the loss function calculating unit 114 may calculate the loss function Loss by using an equation “the loss function Loss=a weight coefficient w_diff×the prediction loss function Loss_diff+a weight coefficient w_grad×the gradient loss function Loss_grad”. In this case, the loss function calculating unit 114 may set (in other words, adjust or change) at least one of the weight coefficient w_diff and the weight coefficient w_grad. An importance (in other words, a contribution) of the prediction loss function Loss_diff in the loss function Loss is larger, as the weight coefficient w_diff is larger. An importance (in other words, a contribution) of the gradient loss function Loss_grad in the loss function Loss is larger, as the weight coefficient w_grad is larger. In this case, at least one of the weight coefficient w_diff and the weight coefficient w_grad may be obtained by the learning apparatus 1 as a hyper parameter at the step S10.

Then, the differentiating unit 115 calculates a differential coefficient of the loss function Loss calculated at the step S16 (a step S17). For example, the differentiating unit 115 calculates the differential coefficient of the loss function Loss with respect to the parameters θ₁ to θₙ.

Then, the parameter updating unit 116 updates the parameters θ₁ to θₙ on the basis of the differential coefficient calculated at the step S115 so that a value of the loss function Loss decreases (a step S18). For example, the parameter updating unit 116 may update the parameters θ₁ to θₙ by using a gradient method based on the differential coefficient calculated at the step S115 so that the value of the loss function Loss decreases. For example, the parameter updating unit 116 may update the parameters θ₁ to θₙ by using a backpropagation method based on the differential coefficient calculated at the step S115 so that the value of the loss function Loss decreases. As a result, the parameter updating unit 116 outputs the updated parameters θ₁ to θₙ (the updated parameters θ₁ to θₙ are illustrated as “parameters θ′₁ to θ′ₙ” in FIG. 2).

Then, the learning apparatus 1 ends the operation illustrated in FIG. 3 after incrementing the updated number of times et (a step S19). Then, the learning apparatus 1 repeats the operation illustrated in FIG. 3 until an update end condition of the parameters θ₁ to θₙ (namely, an update end condition of the machine learning models f₁ to fₙ) is satisfied. The update end condition may include a condition that the error between the output labels y₁ to yₙ of the machine learning models f₁ to fₙ and the ground truth label Y decreases to be equal to or smaller than an allowable value. Moreover, the update end condition may include a condition that the operation illustrated in FIG. 3 is performed a predetermined times or more (note that this predetermined times is larger than the above described threshold value ec). Namely, the update end condition may include a condition that the updated number of times et is equal to or larger than the predetermined times.

### (3) Technical Effect of Learning Apparatus 1

As described above, the learning apparatus 1 in the present example embodiment can update the machine learning models f₁ to fₙ so that the value of the loss function Loss that is calculated both of the prediction loss function Loss_diff and the gradient loss function Loss_grad decreases. In this case, it can be said that decreasing the value of the loss function Loss is equivalent to decreasing both of a value the prediction loss function Loss_diff and a value of the gradient loss function Loss_grad in a balanced manner. The error between the output labels y₁ to yₙ of the machine learning models f₁ to fₙ and the ground truth label Y is smaller, as the value of the prediction loss function Loss_diff is smaller. On the other hand, a space in which there is an adversarial example that is misclassified by all of the machine learning models f₁ to fₙ is narrower, as the value of the gradient loss function Loss_grad is smaller, as disclosed in the Non-Patent Literature 1. Thus, in the present example embodiment, it can be said that the parameter updating unit 116 updates the machine learning models f₁ to fₙ so as to improve a classification accuracy (in other words, an identification accuracy) of a normal sample (namely, a sample that is not the adversarial example) by each of the machine learning models f₁ to fₙ and to decrease a possibility of situation where all of the machine learning models f₁ to fₙ misclassify the adversarial example. As a result, the learning apparatus 1 can properly build the machine learning models f₁ to fₙ that are robust against the adversarial example (moreover, by which the classification accuracy of the normal sample is relatively high).

Moreover, in the present example embodiment, the gradient loss function Loss_grad that is used to calculate the loss function Loss changes depending on the updated number of times et. Specifically, when the updated number of times et is equal to or smaller than the threshold value ec, the gradient loss function Loss_grad based on the gradient ∇ of the prediction loss function Loss_diff is used to calculate the loss function Loss, and when the updated number of times et is larger than the threshold value ec, the gradient loss function Loss_grad that represents zero is used to calculate the loss function Loss. Thus, when the updated number of times et is larger than the threshold value ec, the prediction loss function Loss_diff is used and the gradient loss function Loss_grad is not substantially used to calculate the loss function Loss (namely, to update the machine learning models f₁ to fₙ). Namely, when the updated number of times et is larger than the threshold value ec, the gradient ∇ is not substantially used to calculate the loss function Loss (namely, to update the machine learning models f₁ to fₙ). As a result, when the updated number of times et is larger than the threshold value ec, the gradient loss function Loss_grad based on the gradient ∇ is not necessarily calculated. More specifically, when the updated number of times et is larger than the threshold value ec, the gradient loss calculating unit 113 does not necessarily calculate the gradients ∇₁ to ∇ₙ and does not necessarily calculate the similarity of the gradients ∇₁ to ∇ₙ. Thus, the processing load of the learning apparatus 1 is reduced to an extent that the gradient ∇ is not necessarily calculated, compared to the case where the gradient ∇ is calculated regardless of the number of the updated number of times et. As a result, the learning apparatus 1 in the present example embodiment can update the machine learning models f₁ to fₙ with relatively low processing load, compared to a learning apparatus in a comparison example that calculates the gradient ∇ regardless of the number of the updated number of times et.

Moreover, even though the gradient ∇ is not used to update the machine learning models f₁ to fₙ when the updated number of times et is larger than the threshold value ec, the space in which there is the adversarial example that is misclassified by all of the machine learning models f₁ to fₙ does not excessively widen. This is because the gradient ∇ is used to update the machine learning models f₁ to fₙ when the updated number of times et is equal to or smaller than the threshold value ec, and thus, the machine learning models f₁ to fₙ are updated so that the space in which there is the adversarial example that is misclassified by all of the machine learning models f₁ to fₙ becomes narrower at this step. Namely, when the machine learning models f₁ to fₙ are updated a certain number of times or more (in the present example embodiment, a number of times that corresponds to the threshold value ec or more) by using the gradient ∇, the space in which there is the adversarial example that is misclassified by all of the machine learning models f₁ to fₙ does not excessively widen even when the machine learning models f₁ to fₙ are updated without using the gradient ∇ thereafter. In other words, when the machine learning models f₁ to fₙ are updated a certain number of times or more by using the gradient ∇, a contribution (namely, an influence) of the gradient ∇ to the update of the machine learning models f₁ to fₙ is relatively small thereafter, and thus, the space in which there is the adversarial example that is misclassified by all of the machine learning models f₁ to fₙ does not excessively widen even when the machine learning models f₁ to fₙ are not updated by using the gradient ∇. Therefore, the learning apparatus 1 can properly build the machine learning models f₁ to fₙ that are robust against the adversarial example, substantially as with the case where the machine learning models f₁ to fₙ are updated by using the gradient ∇ even when the updated number of times et is larger than the threshold value ec,

Thus, the threshold value ec that is compared to the updated number of times et may be set to a proper value on the basis of relationship between the updated number of times et and the contribution of the gradient ∇ to the update of the machine learning models f₁ to fₙ. For example, the threshold value ec may be set to a proper value that allows a situation where the contribution of the gradient ∇ to the update of the machine learning models f₁ to fₙ is relatively small and a situation where the contribution of the gradient ∇ to the update of the machine learning models f₁ to fₙ is relatively large to be distinguished on the basis of the updated number of times et. For example, the threshold value ec may be set to a proper value that allows a situation where there is no problem even when the contribution of the gradient ∇ to the update of the machine learning models f₁ to fₙ is small and a situation where a problem arises when the contribution of the gradient ∇ to the update of the machine learning models f₁ to fₙ is small to be distinguished on the basis of the updated number of times et. For example, the threshold value ec may be set to a proper value that allows a situation where it is desired to update the machine learning models f₁ to fₙ by using the gradient ∇ and a situation where the machine learning models f₁ to fₙ can be updated without using the gradient ∇ to be distinguished on the basis of the updated number of times et.

Moreover, in the present example embodiment, a constraint of the activation function for preventing the contribution of the gradient loss function Loss_grad to the update of the machine learning models f₁ to fₙ from being small, which is disclosed in the Non-Patent Literature 1, is eased. This is because the gradient ∇ is not used to update the machine learning models f₁ to fₙ after the machine learning models f₁ to fₙ are updated by using the gradient ∇ a certain number of times or more. Namely, this is because there is no problem even when the contribution of the gradient ∇ to the update of the machine learning models f₁ to fₙ is small after the machine learning models f₁ to fₙ are updated by using the gradient ∇ a certain number of times or more. As a result, in the present example embodiment, the Leaky ReLu function is not necessarily used as the activation function. Namely, in the present example embodiment, a function (for example, the ReLu function) the processing load necessary for updating the machine learning models f₁ to fₙ of which is lower than that of the Leaky ReLu function can be used as the activation function. Thus, the processing load necessary for updating the machine learning models f₁ to fₙ becomes lower, compared to the case where the Leaky ReLu function is necessarily used as the activation function. In this respect, the learning apparatus 1 can update the machine learning models f₁ to fₙ with relatively low processing load.

### (4) Modified Example

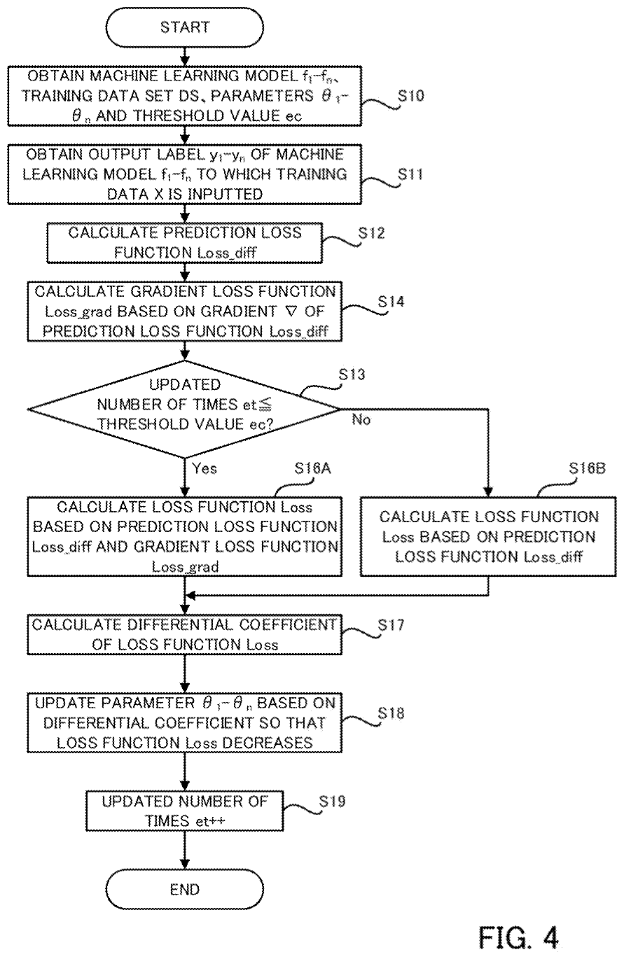

As described above, calculating the gradient loss function Loss_grad that represents zero when the updated number of times et is larger than the threshold value ec is substantially equivalent to calculating the loss function Loss without using the gradient loss function Loss_grad when the updated number of times et is larger than the threshold value ec. Namely, calculating the gradient loss function Loss_grad that represents zero when the updated number of times et is larger than the threshold value ec is substantially equivalent to updating the machine learning models f₁ to fₙ without using the gradient loss function Loss_grad when the updated number of times et is larger than the threshold value ec. Thus, the loss function calculating unit 114 may (i) calculate the loss function Loss on the basis of both of the prediction loss function Loss_diff and the gradient loss function Loss_grad when the updated number of times et is equal to or smaller than the threshold value ec (a step S16a in FIG. 4) and (ii) calculate the loss function Loss on the basis of the prediction loss function Loss_diff without using the gradient loss function Loss_grad when the updated number of times et is not equal to or smaller than the threshold value ec (a step S16b in FIG. 4), in calculating the loss function Loss, as illustrated in a flowchart of FIG. 4. Even in this case, the fact remains that the constraint of the activation function is eased, and thus, the learning apparatus 1 can update the machine learning models f₁ to fₙ with relatively low processing load. Note that the gradient loss calculating unit 113 may calculate the gradient loss function Loss_grad based on the gradient ∇ regardless of the updated number of times et as illustrated in FIG. 4 or may change a method of calculating the gradient loss function Loss_grad on the basis of the updated number of times et as illustrated in FIG. 2.

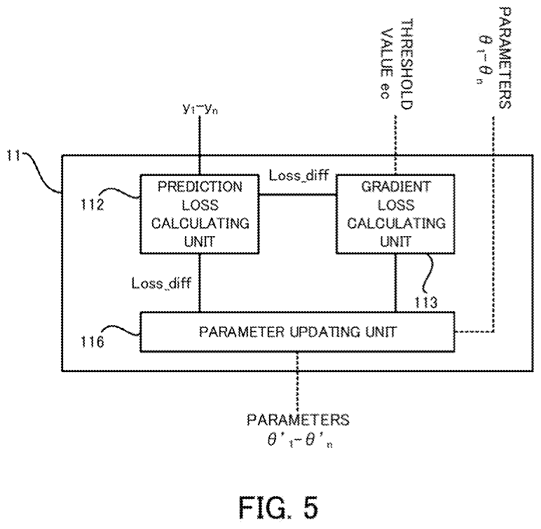

In the above described description, the learning apparatus 1 is provided with the predicting unit 111, the loss function calculating unit 114 and the differentiating unit 115. However, the learning apparatus 1 may not be provided with at least one of the predicting unit 111, the loss function calculating unit 114 and the differentiating unit 115. For example, as illustrated in FIG. 5, the learning apparatus 1 may not be provided with all of the predicting unit 111, the loss function calculating unit 114 and the differentiating unit 115. When the learning apparatus 1 is not provided with the predicting unit 111, the output labels y₁ to yₙ that are outputted from the machine learning models f₁ to fₙ, respectively, may be inputted to the learning apparatus 1. When the learning apparatus 1 is not provided with the loss function calculating unit 114, the parameter updating unit 116 may update the machine learning models f₁ to fₙ on the basis of the prediction loss function Loss_diff and the gradient loss function Loss_grad without calculating the loss function Loss. Alternatively, when the learning apparatus 1 is not provided with the loss function calculating unit 114, the parameter updating unit 116 may calculate the loss function Loss and then update the machine learning models f₁ to fₙ on the basis of the calculated loss function Loss. When the learning apparatus 1 is not provided with the differentiating unit 115, the parameter updating unit 116 may update the machine learning models f₁ to fₙ without calculating the differential coefficient of the loss function Loss (alternatively, without using the differential coefficient). Alternatively, when the learning apparatus 1 is not provided with the differentiating unit 115, the parameter updating unit 116 may calculate the 1 differential coefficient of the loss function Loss and then update the machine learning models f₁ to fₙ. The point is that the learning apparatus 1 may update the machine learning models f₁ to fₙ by using any method as long as the machine learning models f₁ to fₙ can be updated on the basis of the prediction loss function Loss_diff and the gradient loss function Loss_grad.

### (5) Supplementary Note

With respect to the example embodiments described above, the following Supplementary Notes will be further disclosed.

(5-1) Supplementary Note 1

A learning apparatus described in Supplementary Note 1 is a learning apparatus including: a prediction loss calculating device that calculates a prediction loss function based on an error between outputs of a plurality of machine learning models to which training data is inputted and a ground truth label corresponding to the training data; a gradient loss calculating device that calculates a gradient loss function based on a gradient of the prediction loss function; and an updating device that performs an update operation of updating the plurality of machine learning models on the basis of the prediction loss function and the gradient loss function, the gradient loss calculating device (i) calculates the gradient loss function based on the gradient when the number of times which the update operation is performed is smaller than a predetermined number, and (ii) calculates a function that represents zero as the gradient loss function when the number of times which the update operation is performed is larger than the predetermined number.

(5-2) Supplementary Note 2

A learning apparatus described in Supplementary Note 2 is the learning apparatus described in the Supplementary Note 1, wherein the updating device (i) performs the update operation on the basis of both of the prediction loss function and the gradient loss function when the number of times which the update operation is performed is smaller than the predetermined number, and (ii) performs the update operation on the basis of the prediction loss function without using the gradient loss function when the number of times which the update operation is performed is larger than the predetermined number.

(5-3) Supplementary Note 3

A learning apparatus described in Supplementary Note 3 is a learning apparatus including: a prediction loss calculating device that calculates a prediction loss function based on an error between outputs of a plurality of machine learning models to which training data is inputted and a ground truth label corresponding to the training data; a gradient loss calculating device that calculates a gradient loss function based on a gradient of the prediction loss function; and an updating device that performs an update operation of updating the plurality of machine learning models on the basis of at least one of the prediction loss function and the gradient loss function, the updating device (i) performs the update operation on the basis of both of the prediction loss function and the gradient loss function when the number of times which the update operation is performed is smaller than a predetermined number, and (ii) performs the update operation on the basis of the prediction loss function without using the gradient loss function when the number of times which the update operation is performed is larger than the predetermined number.

(5-4) Supplementary Note 4

A learning apparatus described in Supplementary Note 4 is the learning apparatus described in any one of the Supplementary Notes 1 to 3, wherein the prediction loss calculating device calculates a plurality of prediction loss functions that correspond to the plurality of machine learning models, respectively, and the gradient loss calculating device calculates the gradient loss function based on a similarly of gradients of the plurality of prediction loss functions.

(5-5) Supplementary Note 5

A learning apparatus described in Supplementary Note 5 is the learning apparatus described in the Supplementary Note 4, wherein the gradient loss calculating device calculates the gradient loss function based on a cosine similarity of the gradients of the plurality of prediction loss functions.

(5-6) Supplementary Note 6

A learning apparatus described in Supplementary Note 6 is the learning apparatus described in any one of the Supplementary Notes 1 to 5, wherein the updating device performs the update operation so that a differential coefficient of a final loss function based on the prediction loss function and the gradient loss function decreases.

(5-7) Supplementary Note 7

A learning method described in Supplementary Note 7 is a learning method including: a prediction loss calculating step that calculates a prediction loss function based on an error between outputs of a plurality of machine learning models to which training data is inputted and a ground truth label corresponding to the training data; a gradient loss calculating step that calculates a gradient loss function based on a gradient of the prediction loss function; and an updating step that performs an update operation of updating the plurality of machine learning models on the basis of the prediction loss function and the gradient loss function, at the gradient loss calculating step, (i) the gradient loss function based on the gradient is calculated when the number of times which the update operation is performed is smaller than a predetermined number, and (ii) a function that represents zero is calculated as the gradient loss function when the number of times which the update operation is performed is larger than the predetermined number.

(5-8) Supplementary Note 8

A learning method described in Supplementary Note 8 is a learning method including: a prediction loss calculating step that calculates a prediction loss function based on an error between outputs of a plurality of machine learning models to which training data is inputted and a ground truth label corresponding to the training data; a gradient loss calculating step that calculates a gradient loss function based on a gradient of the prediction loss function; and an updating step that performs an update operation of updating the plurality of machine learning models on the basis of at least one of the prediction loss function and the gradient loss function, at the updating step, (i) the update operation is performed on the basis of both of the prediction loss function and the gradient loss function when the number of times which the update operation is performed is smaller than a predetermined number, and (ii) the update operation is performed on the basis of the prediction loss function without using the gradient loss function when the number of times which the update operation is performed is larger than the predetermined number.

(5-9) Supplementary Note 9

A computer program described in Supplementary Note 9 is a computer program that allows a computer to execute the learning method described in Supplementary Note 7 or 8.

(5-10) Supplementary Note 10

A recording medium described in Supplementary Note 10 is a recording medium on which the computer program described in Supplementary Note 9 is recorded.

The present invention is allowed to be changed, if desired, without departing from the essence or spirit of the invention which can be read from the claims and the entire specification, and a learning apparatus, a learning method, a computer program and a recording medium, which involve such changes, are also intended to be within the technical scope of the present invention.

### DESCRIPTION OF REFERENCE CODES

1 Learning apparatus
11 CPU
111 predicting unit
112 prediction loss calculating unit
113 gradient loss calculating unit
114 loss function calculating unit
115 differentiating unit
116 parameter updating unit
f₁ to fₙ machine learning model
θ₁ to θₙ parameter
DS training data set
X training data
Y ground truth label
y₁ to yₙ output label
Loss_diff prediction loss function
Loss_grad gradient loss function
Loss loss function
et updated number of times
ec threshold value

What is claimed is:

1. A learning apparatus comprising a controller,
the controller being programmed to:
calculate a prediction loss function based on an error between outputs of a plurality of machine learning models to which training data is inputted and a ground truth label corresponding to the training data;
calculate a gradient loss function based on a gradient of the prediction loss function; and
perform an update operation of updating the plurality of machine learning models on the basis of the prediction loss function and the gradient loss function,
the controller being programmed to (i) calculate the gradient loss function based on the gradient when the number of times which the update operation is performed is smaller than a predetermined number, and (ii) calculate a function that represents zero as the gradient loss function when the number of times which the update operation is performed is larger than the predetermined number.

2. The learning apparatus according to claim 1, wherein
the controller is programmed to (i) perform the update operation on the basis of both of the prediction loss function and the gradient loss function when the number of times which the update operation is performed is smaller than the predetermined number, and (ii) perform the update operation on the basis of the prediction loss function without using the gradient loss function when the number of times which the update operation is performed is larger than the predetermined number.

3. A learning apparatus comprising a controller,
the controller being programmed to:
calculate a prediction loss function based on an error between outputs of a plurality of machine learning models to which training data is inputted and a ground truth label corresponding to the training data;
calculate a gradient loss function based on a gradient of the prediction loss function; and
perform an update operation of updating the plurality of machine learning models on the basis of at least one of the prediction loss function and the gradient loss function,
the controller being programmed to (i) perform the update operation on the basis of both of the prediction loss function and the gradient loss function when the number of times which the update operation is performed is smaller than a predetermined number, and (ii) perform the update operation on the basis of the prediction loss function without using the gradient loss function when the number of times which the update operation is performed is larger than the predetermined number.

4. A learning method including:
calculating a prediction loss function based on an error between outputs of a plurality of machine learning models to which training data is inputted and a ground truth label corresponding to the training data;
calculating a gradient loss function based on a gradient of the prediction loss function; and
performing an update operation of updating the plurality of machine learning models on the basis of the prediction loss function and the gradient loss function,
calculating the gradient loss function including (i) calculating the gradient loss function based on the gradient when the number of times which the update operation is performed is smaller than a predetermined number, and (ii) calculating a function that represents zero as the gradient loss function when the number of times which the update operation is performed is larger than the predetermined number.

5. A learning method including:
calculating a prediction loss function based on an error between outputs of a plurality of machine learning models to which training data is inputted and a ground truth label corresponding to the training data;
calculating a gradient loss function based on a gradient of the prediction loss function; and
performing an update operation of updating the plurality of machine learning models on the basis of at least one of the prediction loss function and the gradient loss function,
performing the update operation including (i) performing the update operation on the basis of both of the prediction loss function and the gradient loss function when the number of times which the update operation is performed is smaller than a predetermined number, and (ii) performing the update operation on the basis of the prediction loss function without using the gradient loss function when the number of times which the update operation is performed is larger than the predetermined number.

6. (canceled)

7. A non-transitory recording medium on which a computer program recorded, wherein
the computer allows a computer to execute a learning method,
the learning method includes:
calculating a prediction loss function based on an error between outputs of a plurality of machine learning models to which training data is inputted and a ground truth label corresponding to the training data;
calculating a gradient loss function based on a gradient of the prediction loss function; and
performing an update operation of updating the plurality of machine learning models on the basis of the prediction loss function and the gradient loss function,
calculating the gradient loss function includes (i) calculating the gradient loss function based on the gradient when the number of times which the update operation is performed is smaller than a predetermined number, and (ii) calculating a function that represents zero as the gradient loss function when the number of times which the update operation is performed is larger than the predetermined number.

8. A non-transitory recording medium on which a computer program is recorded, wherein
the computer program allows a computer to execute a learning method,
the learning method includes:
calculating a prediction loss function based on an error between outputs of a plurality of machine learning models to which training data is inputted and a ground truth label corresponding to the training data;
calculating a gradient loss function based on a gradient of the prediction loss function; and
performing an update operation of updating the plurality of machine learning models on the basis of at least one of the prediction loss function and the gradient loss function,
performing the update operation includes (i) performing the update operation on the basis of both of the prediction loss function and the gradient loss function when the number of times which the update operation is performed is smaller than a predetermined number, and (ii) performing the update operation on the basis of the prediction loss function without using the gradient loss function when the number of times which the update operation is performed is larger than the predetermined number.
